(19) United States
(12) Patent Application Publication
(10) Pub. No.: US 2025/0321110 A1
(43) Pub. Date: Oct. 16, 2025

(54) ROUTE PLANNING METHOD, NAVIGATION METHOD, SYSTEM AND VEHICLE FOR DRIVING PRACTICE SCENARIOS

(71) Applicant: CARIAD (China) Co., Ltd., Beijing (CN)

(72) Inventors: Xinyue LIU, Beijing (CN); Yuheng YIN, Beijing (CN); Linying ZHANG, Beijing (CN)

(21) Appl. No.: 19/034,119

(22) Filed: Jan. 22, 2025

(30) Foreign Application Priority Data
Jan. 22, 2024 (CN) 202410089290.5

(51) Int. Cl. G01C 21/34; G09B 5/04; G09B 5/06

(52) U.S. Cl. CPC G01C 21/3484; G01C 21/3492; G09B 5/04; G09B 5/065

(57) ABSTRACT

Disclosed is a route planning method and system and a navigation method and system for a driving training scenario, and a vehicle. The route planning method comprises: on the basis of static and dynamic attributes related to a road, classifying and marking the road by using different levels of driving practice difficulty; and setting, on the basis of driving training preferences of a user, a route planned for the driving training scenario. The navigation method comprises: on the basis of a route planned by the route planning method, providing route guidance to a user through audio broadcast and/or video display.

### TECHNICAL FIELD

The present disclosure relates to the technical field of road traffic, and in particular, to a route planning method and system and a navigation method and system for a driving training scenario, and a vehicle.

### BACKGROUND

As the navigation system and autonomous driving technology develop continuously, how to plan an optimal route is an important and popular subject. The current study on the route planning for a navigation system or an autonomous driving vehicle focuses on how to use GPS information, map information, and sensing information of a vehicle sensor to plan an optimal route.

In the prior art, compared with conventional and known route planning methods, there are 2-3 alternative routes for a user to select during navigation. Different routes are generally planned on the basis of factors such as an overall distance of a route, whether an expressway section is passed through, the number of toll stations in the route, the number of traffic lights in the route, congestion status in the route, or the like.

The selectivity of different driving routes provided by existing navigation systems or vehicles is very limited, which is almost the same for all users, such that requirements of the users for special route customization and selection cannot be met. Moreover, user interaction after selecting a corresponding route is very limited or almost non-existent. Furthermore, in a navigation system in the prior art, the users may select their own preferences such as expressway priorities, distance priorities, time priorities, or the like to perform route planning and navigation. However, such selection is still very sketchy and common. Thus, the existing navigation systems or vehicles equipped with navigation systems used by people must rely on other information to realize special route planning and selection of specific scenarios (e.g. a driving training scenario for a novice driver or inexperienced driver).

In the prior art, conventional and known route planning methods are that users must set a “start point” and an “end point” or a “stopover point”, and are on the basis of the fundamental requirement of “arriving at” the end point or stopover point, which cannot meet the requirements of the novice driver or inexperienced driver for the special route of the driving training scenario: instead of taking “arriving” as a fundamental objective, an “end point” does not need to be set, and “a driving duration”, “driving practice difficulty”, “a driving scenario”, or the like are taken as the fundamental core requirements.

### SUMMARY

In order to solve the described problems in prior art, the present disclosure provides a route planning method and system and a navigation method and system, and a vehicle, so as to provide intelligent route planning and navigation services for driving training scenarios to users without performing pre-research on road conditions and road areas in order to find an appropriate navigation route.

A first aspect of the present disclosure provides a route planning method for a driving training scenario. The route planning method comprises the following steps: a road difficulty classification step: on the basis of static and dynamic attributes related to a road, classifying and marking the road by using different levels of driving practice difficulty; and a route planning setting step: setting, on the basis of driving training preferences of a user, a route planned for the driving training scenario.

A second aspect of the present disclosure provides a navigation method for a driving training scenario. The navigation method comprises a navigation service step: on the basis of a route planned by the route planning method, providing guidance of the planned route to a user through audio broadcast and/or video display using a guidance method of a virtual driving instructor.

A third aspect of the present disclosure provides a route planning system for a driving training scenario. The route planning system comprises: a road difficulty classification unit, which is configured to classify and mark, on the basis of static and dynamic attributes related to a road, the road by using different levels of driving practice difficulty; and a route planning setting unit, which is configured to set, on the basis of driving training preferences of a user, a route planned for the driving training scenario.

A fourth aspect of the present disclosure provides a navigation system for a driving training scenario. The navigation system comprises: a navigation service unit, which is configured to provide, on the basis of a route planned by the route planning system, guidance of the planned route to a user through audio broadcast and/or video display using a guidance method of a virtual driving instructor.

A fifth aspect of the present disclosure provides a vehicle, comprising the route planning system for a driving training scenario as described above and the navigation system for a driving training scenario as described above.

According to the route planning method and system and the navigation method and system, and the vehicle of the present disclosure, the following beneficial technical effects are achieved:
1. Intelligent route planning and navigation services for a specific driving training scenario are provided without performing any manual pre-research on road conditions and areas for finding any appropriate navigation route, such that the time for a user to prepare or select a route is reduced.
2. For the specific driving training scenario, the user does not focus on “arriving at an end point” as a special requirement, and a customized route planning and navigation service is provided to focus on solving specific navigation requirements, for example, a driving duration, driving practice difficulty, a driving scenario, or the like.
3. For the specific driving training scenario, on the basis of the static and dynamic attributes from map data and related to roads, all the roads are classified and marked by using different levels of driving practice difficulty. Moreover, by planning a route on the basis of the driving training preferences of the user, the special requirements of a novice driver or less experienced driver for the route planning and navigation services in the driving training scenario are met.
4. For the specific driving training scenario, more complete and enjoyable navigation services and driving feedback services are provided through immersive and interactive guidance during a driving training trip and interactive game-like feedback after the driving training trip.
5. Road and lane data can be classified and marked in advance by flexibly using various classification modes, such that the requirements of the user for route planning and selection in other specific scenarios or requirement situations are met.

### BRIEF DESCRIPTION OF THE DRAWINGS

FIG. 1 is a flowchart of a route planning method for a driving training scenario according to a first embodiment of the present disclosure.

FIG. 2 is a flowchart of a first road difficulty classification step in the route planning method shown in FIG. 1.

FIG. 3 is a flowchart of a second road difficulty classification step in the route planning method shown in FIG. 1.

FIG. 4 is a flowchart of a route planning setting step in the route planning method shown in FIG. 1.

FIG. 5 is a flowchart of a navigation method for a driving training scenario according to a second embodiment of the present disclosure.

FIG. 6 is a flowchart of a driving feedback step in the navigation method shown in FIG. 5.

FIG. 7 is a structural block diagram of a navigation system for a driving training scenario according to a third embodiment of the present disclosure.

FIG. 8 is a structural block diagram of a first road difficulty classification unit in the navigation system shown in FIG. 7.

FIG. 9 is a structural block diagram of a second road difficulty classification unit in the navigation system shown in FIG. 7.

FIG. 10 is a structural block diagram of a route planning setting unit in the navigation system shown in FIG. 7.

FIG. 11 is a structural block diagram of a navigation system for a driving training scenario according to a fourth embodiment of the present disclosure.

FIG. 12 is a structural block diagram of a driving feedback unit in the navigation system shown in FIG. 11.

FIG. 13A-FIG. 13F are schematic display diagrams of static and dynamic attributes related to a road used in each embodiment of the present disclosure.

FIG. 14 is a schematic display diagram of the use of driving practice difficulty to classify and mark a road in each embodiment of the present disclosure.

FIG. 15A-FIG. 15D are schematic diagrams of input display of driving training preference information in each embodiment of the present disclosure.

FIG. 16 is a schematic display diagram of a variety of driving feedback in each embodiment of the present disclosure.

### DETAILED DESCRIPTION OF THE EMBODIMENTS

In order to make a person skilled in the art better understand the technical solutions of the present disclosure, the technical solutions in the embodiments of the present disclosure will be clearly and completely described below in combination with the drawings. It is apparent that the described embodiments are only part of the embodiments of the present disclosure, not all the embodiments. On the basis of the embodiments disclosed in the present application, all other embodiments obtained by the person skilled in the art without creative work shall fall within the protection scope of the present disclosure.

It is to be noted that, the terms “comprising” and “having”, as well as any variations thereof, in the specification and claims of the present disclosure and the drawings, are intended to cover non-exclusive embodiments, for example, a process, system, product, or apparatus comprising a series of steps or units requirement not be limited to those steps or units clearly listed, but may comprise other steps or units not clearly listed or inherent to those processes, systems, products or apparatus.

In the present disclosure, the quantifiers “a” and “one” do not exclude scenarios with more than one element, unless otherwise indicated.

It should also be noted herein that, in the embodiments of the present disclosure, only a portion of parts or components may be shown for clarity and simplicity. However, ordinary skill in the art will be able to understand that under the guidance of the present disclosure, desired parts or components may be added as needed for specific scenarios. Furthermore, features in different embodiments of the present disclosure may be combined with each other unless otherwise indicated.

Furthermore, the numbering of steps of various methods of the present disclosure does not limit the sequence in which the method steps are performed. Unless otherwise indicated, the method steps may be performed in a different sequence.

A route planning method and system and a navigation method and system for a driving training scenario, and a vehicle provided in the present disclosure are further described in detail below with reference to the drawings and specific embodiments. The advantages and features of the present disclosure will become clearer according to the description below. It is to be noted that, all the drawings are in a very simple form and in an inaccurate scale, and are merely intended to assist description of the purpose of the embodiments of the present disclosure conveniently and clearly.

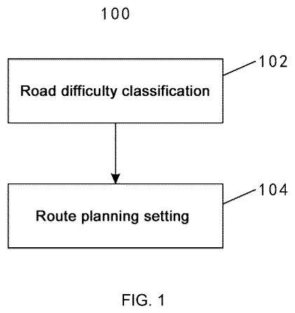

First, with reference to FIG. 1, FIGS. 13A-13F, and FIGS. 15A-15D, FIG. 1 shows a route planning method 100 for a driving training scenario according to a first embodiment of the present disclosure. The route planning method 100 is implemented through a vehicle-mounted navigation system of a vehicle or by combining the vehicle-mounted navigation system of the vehicle with a cloud server connected to the vehicle-mounted navigation system, and comprises the following steps:

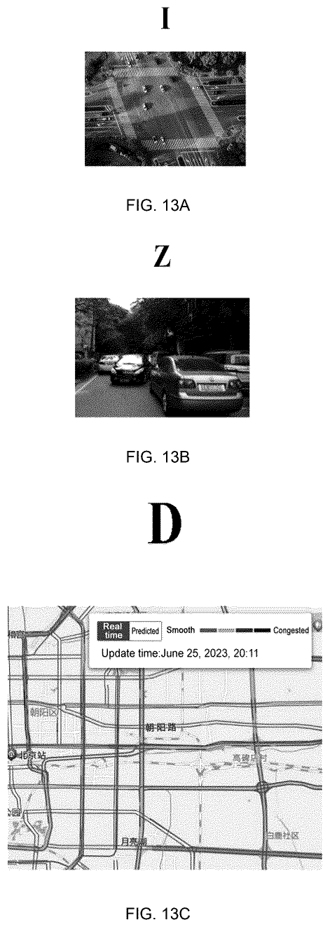

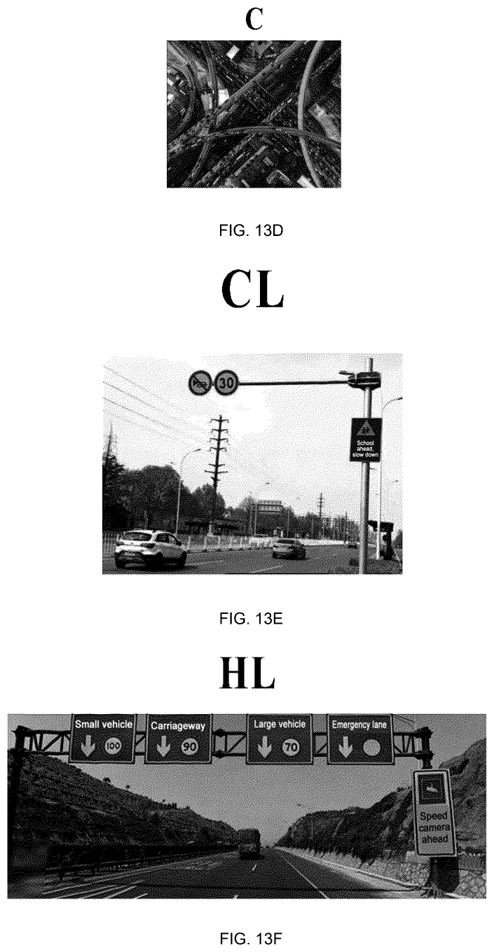

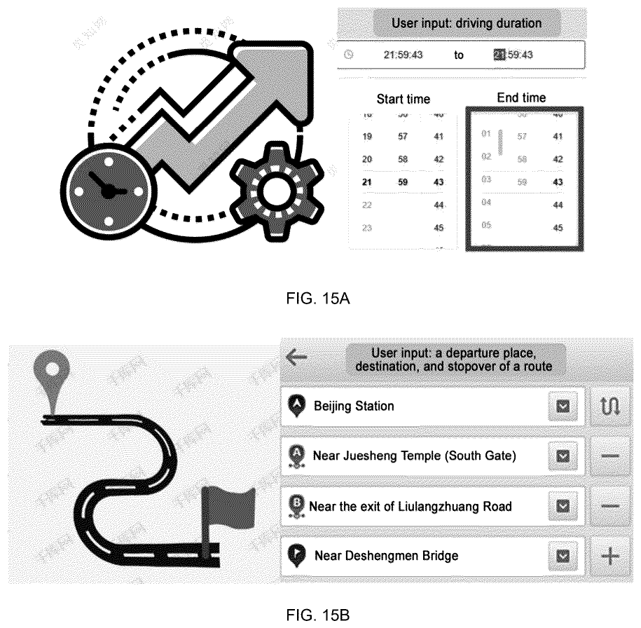

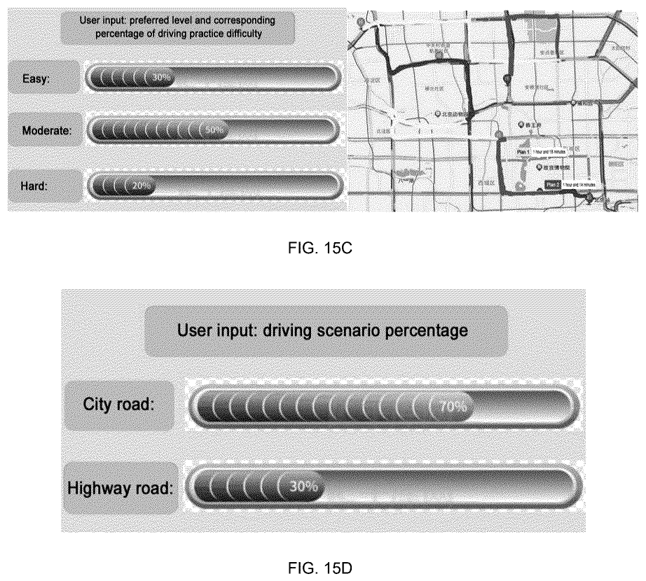

A road difficulty classification step 102: on the basis of static and dynamic attributes related to a road, classifying and marking the road by using different levels of driving practice difficulty. The classification and marking of the driving practice difficulty of the road are used as basic input data for route planning and navigation route calculation. The static and dynamic attributes related to the road include, but are not limited to, at least one of: the number of intersections in the road, road topological complexity (e.g. one road intersecting with several roads), whether there is a road divider (isolation of oncoming vehicles in an opposite direction, or isolation of unprotected pedestrians, bicycle or motorcycle riders, or tricycles in the same direction, etc.), dynamic traffic information (traffic flows, or traffic congestion situations), a road speed limit, or the like. See FIGS. 13A-13F for specific examples of the static and dynamic attributes related to the road; as shown in FIGS. 13A-13F, the static and dynamic attributes related to the road include, but are not limited to, the number of intersections I in the road, road topological complexity C, whether there is a road divider Z, dynamic traffic information D, a road speed limit comprising a city road speed limit CL or highway speed limit HL, or the like; and a route planning setting step 104: on the basis of driving preferences of a user, setting a route planned for the driving training scenario, wherein the driving training preferences of the user include, but are not limited to, at least one of the following categories: a driving duration, a departure place of the route, a stopover, a preferred level and corresponding percentage of driving practice difficulty, a preferred driving scenario percentage, or the like. See FIGS. 15A-15D for examples of input display of driving training preference information of the user, FIG. 15A exemplarily shows a driving duration inputted by the user. FIG. 15B exemplarily shows a departure place, destination, and stopover of a route inputted by the user (in other cases, the user may only input the departure place and stopover of the route, and then set the destination during a trip). FIG. 15C exemplarily shows a preferred level and corresponding percentage of driving practice difficulty inputted by the user (for example, the preferred levels of driving practice difficulty are easy E, moderate M, and hard H, and the corresponding percentages are 30% for easy E, 50% for moderate M, and 20% for hard H). FIG. 15D exemplarily shows a preferred driving scenario percentage inputted by the user (for example, 70% for city roads, and 30% for highway roads).

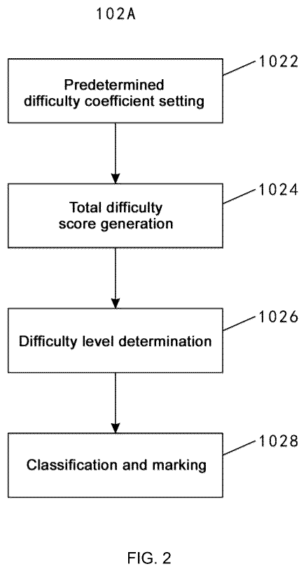

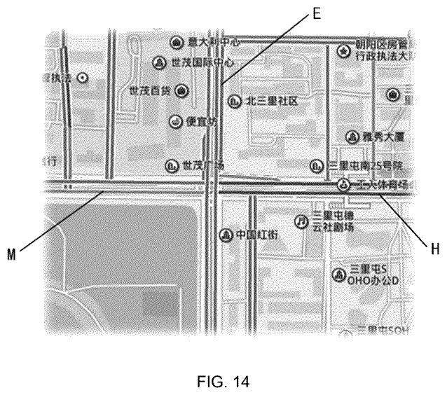

With reference to FIG. 2 and FIG. 14, FIG. 2 shows a first road difficulty classification step 102A in the route planning method 100 shown in FIG. 1. The first road difficulty classification step 102A comprises the following steps:

A predetermined difficulty coefficient setting step 1022: setting a plurality of corresponding predetermined difficulty coefficients for different static or dynamic attributes of the road. For example, a predetermined difficulty coefficient of a straight road or a road and lane with minimal traffic is set to 1; a predetermined difficulty coefficient of a narrow road or a bend with a curvature value greater than a first predetermined value (e.g. 0.004 m\hat{ }−1) or a road with a lane count change greater than a second predetermined value (e.g. 2 lanes become 1) is set to 3; and a predetermined difficulty coefficient of a road with unprotected meeting in an opposite direction or a roundabout with a plurality of exits or a road with a large number of electric vehicles/bicycles or a road with no pedestrian protection facilities is set to 5. Definitely, a person skill in the art may understand that according to different specific application situations, the plurality of predetermined difficulty coefficients may be made by using different setting standards.

A total difficulty score generation step 1024: on the basis of the plurality of predetermined difficulty coefficients, generating a total difficulty score for each section of the road. For example, a total difficulty score of a narrow road with large curvature and unprotected meeting=3 (a predetermined difficulty coefficient of the narrow road)+3 (the predetermined difficulty coefficient of the bend with the curvature value greater than the first predetermined value)+5 (the predetermined difficulty coefficient of the road with unprotected meeting)=11.

A difficulty level determination step 1026: according to an interval in which the total difficulty score of each section of the road is located, determining a level of driving practice difficulty of each section of the road. For example, the level of driving practice difficulty corresponding to an interval 0-3 in which the total difficulty score is located is easy E; the level of driving practice difficulty corresponding to an interval 3-9 in which the total difficulty score is located is moderate M; and the level of driving practice difficulty corresponding to an interval >9 in which the total difficulty score is located is hard H. Definitely, a person skill in the art may understand that according to different specific application situations, the level of driving practice difficulty may be made by using different setting standards.

A classification and marking step 1028: classifying and marking each section of the road with the level of driving practice difficulty of each section of the corresponding road. For example, each section of the road is marked by using different colors corresponding to the different levels of driving practice difficulty in a navigation map. See FIG. 14 for a specific example of classifying and marking the road by using different levels of driving practice difficulty, as shown in FIG. 14, the different levels of driving practice difficulty comprise easy E, moderate M, and hard H, and are marked by using different corresponding colors in the navigation map, for example, the easy level E is marked with green in the map, the moderate level M is marked with yellow in the map, and the hard level H is marked with red in the map.

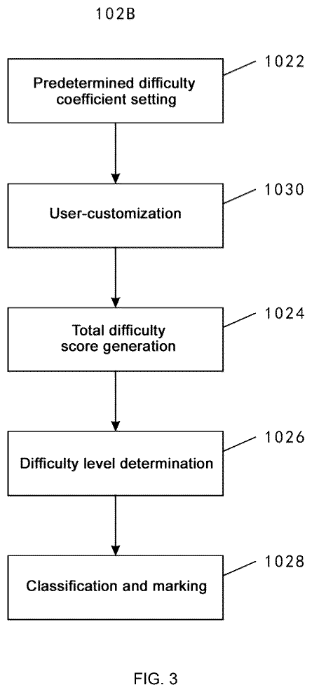

FIG. 3 shows a flowchart of a second road difficulty classification step 102B in the route planning method 100 shown in FIG. 1. A difference between the second road difficulty classification step 102B and the first road difficulty classification step 102A only lies in that: the second road difficulty classification step 102B further comprises a user-customization step 1030 between the predetermined difficulty coefficient setting step 1022 and the total difficulty score generation step 1024: customizing one or more of the plurality of predetermined difficulty coefficients by the user to override the corresponding predetermined difficulty coefficients set in the predetermined difficulty coefficient setting step 1022. For example, a user A considers that a dynamic attribute “unprotected meeting in an opposite direction” of a road is a relatively simple scenario, and thus may define a predetermined difficulty coefficient 5 of the dynamic attribute of the road set in the predetermined difficulty coefficient setting step 1022 as 3, so as to override the predetermined difficulty coefficient set in the predetermined difficulty coefficient setting step 1022.

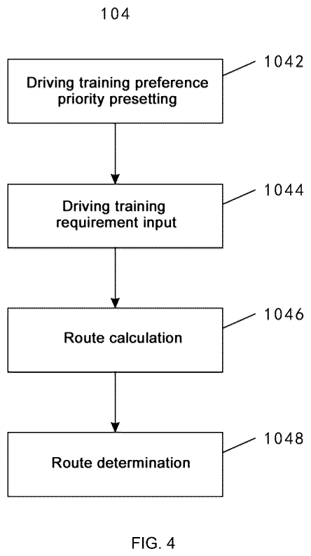

FIG. 4 is a flowchart of a route planning setting step 104 in the route planning method 100 shown in FIG. 1. The route planning setting step 104 specifically comprises the following steps:
a driving training preference priority presetting step 1042: the user presetting priorities of one or more types of driving training preferences through a vehicle-mounted navigation system, and storing same in a processor of the vehicle-mounted navigation system or a cloud server connected to the vehicle-mounted navigation system;
a driving training requirement input step 1044: for the driving training scenario, the user inputting specific numerical values of one or more of the one or more types of driving training preferences, wherein the specific numerical values indicate driving training requirements of the user for the driving training scenario;
a route calculation step 1046: on the basis of the priorities of the one or more types of driving training preferences preset by the user and the input specific numerical values of one or more of the one or more types of driving training preferences, calculating a corresponding route through the vehicle-mounted navigation system or the cloud server connected to the vehicle-mounted navigation system, and providing a calculation result (in this embodiment, the calculation result is displayed on a display interface of the navigation system, and may also definitely be displayed in other replacement manners or combining with voice playback), wherein the calculation result displays a proportion that the calculated corresponding route meets the driving training requirements of the user (e.g. 100% met or 80% met) and/or whether each of the specific numerical values in the driving training requirements is met (e.g. the driving duration is met, the departure place of the route is met, the stopover is not met, the preferred road difficulty and corresponding percentage are met, the preferred driving scenario percentage is not met, or the like); and
a route determination step 1048: on the basis of the calculation result, the user determining whether to accept the calculated corresponding route as a planned route for the driving training scenario; if the user accepts the corresponding route, the vehicle-mounted navigation system starting navigation; and if the user does not accept the corresponding route, returning to the driving training requirement input step 1044 and the user re-inputting modified specific numerical values of one or more of the one or more types of driving training preferences for the driving training scenario. The subsequent steps 1044-1048 are performed continuously.

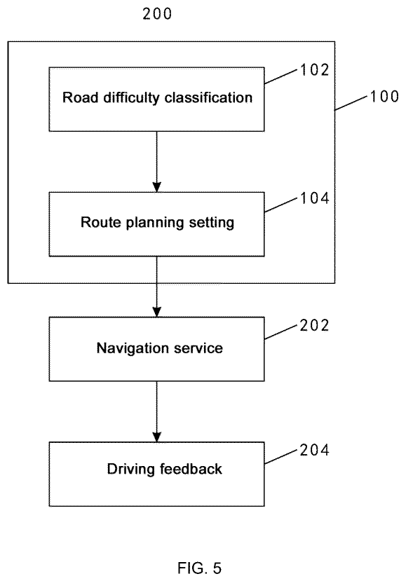

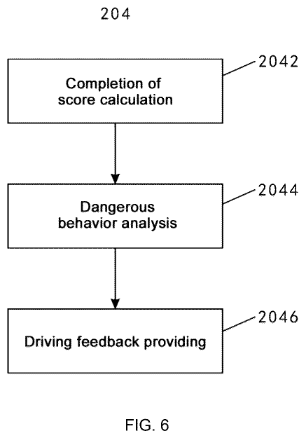

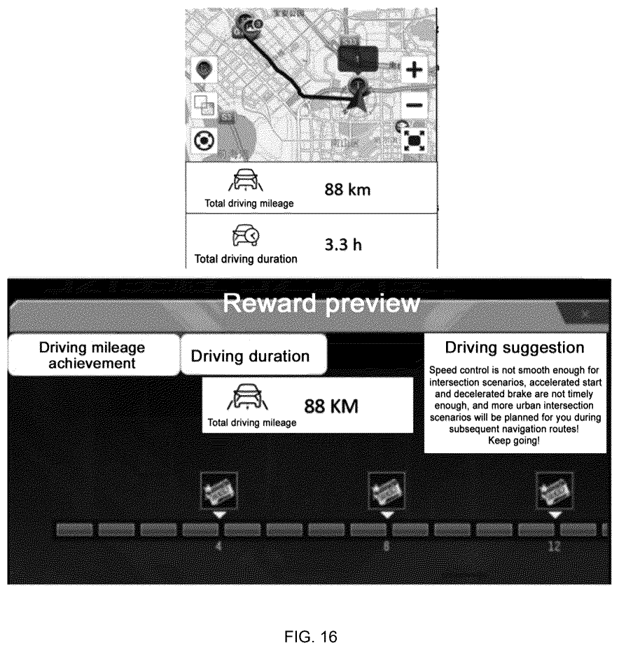

With reference to FIG. 5, FIG. 6 and FIG. 16, FIG. 5 shows a navigation method 200 for a driving training scenario according to a second embodiment of the present disclosure. The navigation method 200 is implemented through a vehicle-mounted navigation system of a vehicle or by combining the vehicle-mounted navigation system of the vehicle with a cloud server connected to the vehicle-mounted navigation system, and comprises the following steps:

A navigation service step 202: on the basis of a route planned by the route planning method 100, the navigation system providing guidance of the planned route to a user through audio broadcast and/or video display using a guidance method of a virtual driving instructor. The guidance method of the virtual driving instructor includes, but is not limited to, contents of the following audio broadcast and/or video display, for example:
1. Guidance for a front scenario or a correct driving behavior:
“Pay attention-you will be faced with a complex road, and please be prepared for this challenge!”;
“Please note that the number of lanes will change after passing the current traffic light, and please observe the target lane in advance”;
“Please note that you will enter a roundabout 500 m ahead of you, and observe the traffic light directly in front of your car during the process of driving around the roundabout”;
“Please slow down and pay attention—200 m ahead is an entrance of an industrial park, and there may be vehicles or pedestrians coming in or going out”;
“Please slow down and be careful to avoid—during the current evening rush hour, there are many vehicles and pedestrians at the intersection ahead of you”; and
“Please be careful to change lanes in advance—the number of lanes ahead is decreasing”.
2. Guidance for encouraging a correct behavior or correcting a wrong behavior for a driven scenario (simulated driving practice instructor):
“Slowed down in time to yield at the left-turn intersection just passed through, well done!”;
“Did not look at the right side of your vehicle at the left-turn intersection just passed through, please pay attention next time”;
“Cheer up! Today's driving practice is already halfway through, so please focus on driving the vehicle, and keep going”; and
“Today's driving practice has reached 1 hour, if you feel tired, I can help you to find the nearest parking lot, please do not drive while tired!”.

A driving feedback step 204: after a driving trip of the route is completed, providing a variety of interactive game-like feedback to the user through the vehicle-mounted navigation system. The driving feedback includes, but is not limited to, celebration at the end of a practice trip (including, but not limited to, seat vibration, sound effects, ambient lighting effects to create a celebratory atmosphere), total mileage statistics of the trip, total duration statistics of the trip, subsequent driving practice route suggestions, or the like.

FIG. 6 shows a flowchart of the driving feedback step 204. The driving feedback step 204 comprises:

a completion score calculation step 2042: obtaining a completion score R by calculation through the following formula and displaying same: R=(A*X)−(B*Y), where A is a total driving practice difficulty score of the road, X is correct driving mileage during the driving trip, B is an erroneous/dangerous driving coefficient (which may be preset by the user or the cloud server, for example, a danger coefficient of controlling the vehicle by frequently fine-tuning steering is 1, a danger coefficient of long-time driving on a solid line is 1, a danger coefficient of not starting the vehicle in time for a green light is 1, a danger coefficient of not slowing down in time for a red light is 2, a danger coefficient of being too close to a front vehicle due to delayed braking is 2, a danger coefficient of not turning on a turn signal during turning is 2, a danger coefficient of quick brake due to failure to observe traffic flow in time at an intersection is 3, a danger coefficient of encountering scratches is 5, or the like), and Y is erroneous driving mileage during the driving trip;
a dangerous behavior analysis step 2044: recording data of a dangerous behavior during the driving trip (e.g. a video of the dangerous behavior captured by a vehicle camera or vehicle data of the dangerous behavior collected by other types of sensors, or the like), analyzing the type and severity of the dangerous behavior (an analysis standard may be preset by the user or the cloud server), and providing an analysis result (e.g. which may be displayed by a display interface of the vehicle-mounted navigation system); and
a driving feedback providing step 2046: on the basis of the completion score and the analysis result, generating a subsequent driving practice route suggestion (e.g. suggesting the user to increase or reduce a difficulty coefficient of a certain route, to increase the proportion of road sections in which the dangerous behavior occurs during a subsequent driving practice route, or the like), and providing driving feedback comprising the subsequent driving practice route suggestion to the user through the vehicle-mounted navigation system.

The recorded data of the dangerous behavior may be stored in the cloud server, and is pushed to other users requiring driving training for reference.

FIG. 16 shows a specific example for the driving feedback. As shown in FIG. 16, the driving feedback comprises total mileage of the trip (e.g. 88 km shown in the figure), a total duration of the trip (e.g. 3.3 h shown in the figure), and the subsequent driving practice route suggestion (e.g. “Speed control is not smooth enough for intersection scenarios, accelerated start and decelerated brake are not timely enough, and more urban intersection scenarios will be planned for you during subsequent navigation routes! Keep going!”).

In one or more embodiments, the route planning method 100 and the navigation method 200 can be combined to obtain a route planning and navigation method for a driving training scenario.

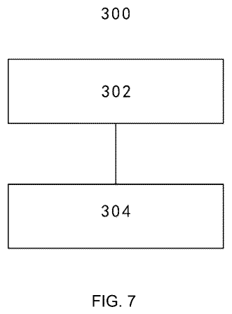

With reference to FIG. 7, FIGS. 13A-13F, and FIGS. 15A-15D, FIG. 7 shows a route planning system 300 for a driving training scenario according to a third embodiment of the present disclosure. The route planning system 300 is implemented through a vehicle-mounted navigation system of a vehicle or by combining the vehicle-mounted navigation system of the vehicle with a cloud server connected to the vehicle-mounted navigation system, and comprises:

A road difficulty classification unit 302, which is configured to classify and mark, on the basis of static and dynamic attributes from map data and related to a road, all roads by using different levels of driving practice difficulty, wherein the classification and marking of the driving practice difficulty of the roads are used as basic input data for intelligent automatic route planning and navigation route calculation. The static and dynamic attributes related to the road include, but are not limited to, the number of intersections in the road, road topological complexity (e.g. one road intersecting with several roads), whether there is a road divider (isolation of oncoming vehicles in an opposite direction, or isolation of unprotected pedestrians, bicycle or motorcycle riders, or tricycles in the same direction, etc.), dynamic traffic information (traffic flows, or traffic congestion situations), a route speed limit, or the like. See FIGS. 13A-13F for specific examples of the static and dynamic attributes related to the road, as shown in FIGS. 13A-13F, the static and dynamic attributes related to the road include, but are not limited to, the number of intersections I in the road, road topological complexity C, whether there is a road divider Z, dynamic traffic information D, a route speed limit (e.g. a city road speed limit CL or highway speed limit HL, or the like.

A route planning setting unit 304, which is configured to set, on the basis of driving training preferences of a user, a route planned for the driving training scenario, wherein the driving training preferences of the user include, but are not limited to, a driving duration, a departure place of the route, a stopover, a preferred level and corresponding percentage of driving practice difficulty, a preferred driving scenario percentage, or the like. See FIGS. 15A-15D for examples of input display of driving training preference information of the user, FIG. 15A exemplarily shows a driving duration inputted by the user. FIG. 15B exemplarily shows a departure place, destination, and stopover of a route inputted by the user (in other cases, the user may only input the departure place and stopover of the route, and then set the destination during a trip). FIG. 15C exemplarily shows a preferred level and corresponding percentage of driving practice difficulty inputted by the user (for example, the preferred levels of driving practice difficulty are easy E, moderate M, and hard H, and the corresponding percentage are 30% for easy E, 50% for moderate M, and 20% for hard H). FIG. 15D exemplarily shows a preferred driving scenario percentage inputted by the user (for example, 70% for city roads, and 30% for highway roads).

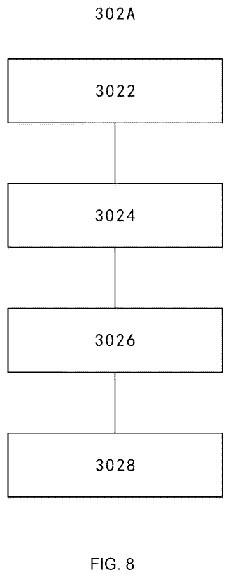

With reference to FIG. 8 and FIG. 14, FIG. 8 shows a first road difficulty classification unit 302A in the route planning system 300 shown in FIG. 7. The first road difficulty classification unit 302A comprises:

A predetermined difficulty coefficient setting unit 3022, which is configured to set a plurality of corresponding predetermined difficulty coefficients for different static or dynamic attributes of the road. For example, a predetermined difficulty coefficient of a straight road or a road/lane with minimal traffic is set to 1; a predetermined difficulty coefficient of a narrow road or a bend with a curvature value greater than a first predetermined value (e.g. 0.004 m\hat{ }−1) or a road/lane with a lane count change greater than a second predetermined value (e.g. 2 lanes become 1) is set to 3; and a predetermined difficulty coefficient of a road with unprotected meeting in an opposite direction or a roundabout with a plurality of exits or a road with a large number of electric vehicles/bicycles or a road with no pedestrian protection facilities is set to 5. Definitely, a person skill in the art may understand that according to different specific application situations, the plurality of predetermined difficulty coefficients may be made by using different setting standards.

A total difficulty score generation unit 3024, which is configured to generate, on the basis of the plurality of predetermined difficulty coefficients, a total difficulty score for each section of the road. For example, a total difficulty score of a narrow road with large curvature and unprotected meeting=3 (a predetermined difficulty coefficient of the narrow road)+3 (the predetermined difficulty coefficient of the bend with the curvature value greater than the first predetermined value)+5 (the predetermined difficulty coefficient of the road with unprotected meeting)=11.

A difficulty level determination unit 3026, which is configured to determine, according to an interval in which the total difficulty score of each section of the road is located, a level of driving practice difficulty of each section of the road. For example, the level of driving practice difficulty corresponding to an interval 0-3 in which the total difficulty score is located is easy E; the level of driving practice difficulty corresponding to an interval 3-9 in which the total difficulty score is located is moderate M; and the level of driving practice difficulty corresponding to an interval >9 in which the total difficulty score is located is hard H. Definitely, a person skill in the art may understand that according to different specific application situations, the level of driving practice difficulty may be made by using different setting standards.

A classification and marking unit 3028, which is configured to classify and mark each section of the road with the level of driving practice difficulty of each section of the road. For example, each section of the road is marked by using different colors corresponding to the different levels of driving practice difficulty in a navigation map. See FIG. 14 for a specific example of classifying and marking the road by using the different levels of driving practice difficulty; as shown in FIG. 14, the different levels of driving practice difficulty comprise easy E, moderate M, and hard H, and are marked by using different corresponding colors in the navigation map, for example, the easy level E is marked with green in the map, the moderate level M is marked with yellow in the map, and the hard level H is marked with red in the map.

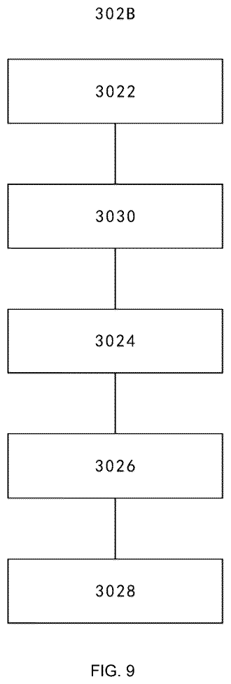

FIG. 9 shows a second road difficulty classification unit 302B in the route planning system 300 shown in FIG. 7. A difference between the second road difficulty classification unit 302B and the first road difficulty classification unit 302A lies in that: the road difficulty classification unit 302 further comprises a user-customization unit 3030, which is configured to customize one or more of the plurality of predetermined difficulty coefficients by the user to override the corresponding predetermined difficulty coefficients set by the predetermined difficulty coefficient setting unit 3022. For example, a user A considers that a dynamic attribute “unprotected meeting in an opposite direction” of a road is a relatively simple scenario, and thus may define a predetermined difficulty coefficient 5 corresponding to the dynamic attribute of the road and set by the predetermined difficulty coefficient setting unit 3022 as 3, so as to override the predetermined difficulty coefficient set by the predetermined difficulty coefficient setting unit 3022.

Definitely, on the basis of different requirements of the user, variations of each embodiment may be implemented, for example, in the road difficulty classification step 102 or the road difficulty classification unit 302 (comprising 302A and 302B), all the roads are classified and marked on the basis of one or more of the following in addition to the driving practice difficulty: driving styles on the roads (comfort, sport, energy saving, or the like), road layouts (three or more lanes, two lanes, a single lane, or the like), road landscape layouts (more roadside trees, more flower configurations, or the like), and other special road situations (more left-turn driving requirements or more right-turn driving requirements).

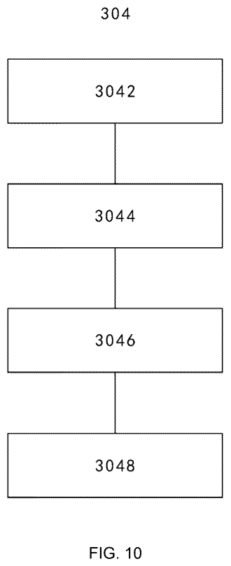

FIG. 10 is a structural block diagram of a route planning setting unit 304 in the route planning system 300 shown in FIG. 7. The route planning setting unit 304 comprises:
a driving training preference priority presetting unit 3042, which is configured to allow the user to preset priorities of one or more types of driving training preferences through a vehicle-mounted navigation system, and store same in a cloud server;
a driving training requirement input unit 3044, which is configured to allow, for the driving training scenario, the user to input specific numerical values of one or more of the one or more types of driving training preferences, wherein the specific numerical values indicate driving training requirements of the user for the driving training scenario;
a route calculation unit 3046, which is configured to calculate a corresponding route on the basis of the priorities of the one or more types of driving training preferences preset by the user and the input specific numerical values of one or more of the one or more types of driving training preferences, and provide a calculation result (in this embodiment, the calculation result is displayed on a display interface of the navigation system, and may also definitely be displayed in other replacement manners of or combining with voice playing), wherein the calculation result displays a proportion that the calculated corresponding route meets the driving training requirements of the user (e.g. 100% met or 80% met) and/or whether each of the specific numerical values in the driving training requirements is met (e.g. the driving duration is met, the departure place of the route is met, the stopover is not met, the preferred driving difficulty and corresponding percentage are met, the preferred driving scenario percentage is not met, or the like); and
a route determination unit 3048, which is configured to allow the user to determine, on the basis of the calculation result, whether to accept the calculated corresponding route as a planned route set for the driving training scenario; to start a navigation service by a navigation service unit 306 if the user accepts the corresponding route; and to re-input by the user modified specific numerical values of one or more of the one or more types of driving training preferences for the driving training scenario through the driving training requirement input unit 3044 if the user does not accept the corresponding route.

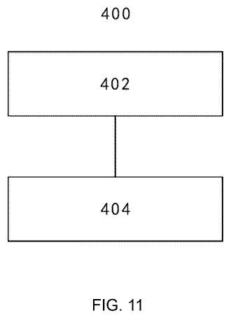

With reference to FIGS. 11-12 and FIG. 16, FIG. 11 shows a navigation system 400 for a driving training scenario according to a fourth embodiment of the present disclosure. The navigation system 400 comprises a navigation service unit 402, which is configured to provide, on the basis of a route planned by the route planning system 300, guidance of the planned route to a user through audio broadcast and/or video display using a guidance method of a virtual driving instructor. The guidance method of the virtual driving instructor includes, but is not limited to, contents of the following audio broadcast and/or video display, for example:
1. Guidance for a front scenario or a correct driving behavior:
“Pay attention-you will be faced with a complex road, and please be prepared for this challenge!”;
“Please note that the number of lanes will change after passing the current traffic light, and please observe the target lane in advance”;
“Please note that you will enter a roundabout 500 m ahead of you, and observe the traffic light directly in front of your car during the process of driving around the roundabout”;
“Please slow down and pay attention—200 m ahead is an entrance of an industrial park, and there may be vehicles or pedestrians coming in or going out”;
“Please slow down and be careful to avoid—during the current evening rush hour, there are many vehicles and pedestrians at the intersection ahead of you”; and
“Please be careful to change lanes in advance—the number of lanes ahead is decreasing”; and
2. Guidance for encouraging a correct behavior or correcting a wrong behavior for a driven scenario (simulated driving practice instructor)
“Slowed down in time to yield at the left-turn intersection just passed through, well done!”;
“Did not look at the right side of your vehicle at the left-turn intersection just passed through, please pay attention next time”;
“Cheer up! Today's driving practice is already halfway through, so please focus on driving the vehicle, and keep going”; and
“Today's driving practice has reached 1 h, if you feel tired, I can help you to find the nearest parking lot, please do not drive while tired!”.

A driving feedback unit 404, which is configured to provide, after a driving trip of the route is completed, a variety of interactive game-like feedback to the user through a vehicle-mounted navigation system. The driving feedback includes, but is not limited to, celebration at the end of a practice trip (including, but not limited to, seat vibration, sound effects, ambient lighting effects to create a celebratory atmosphere), total mileage statistics of the trip, total duration statistics of the trip, subsequent driving practice route suggestions, or the like.

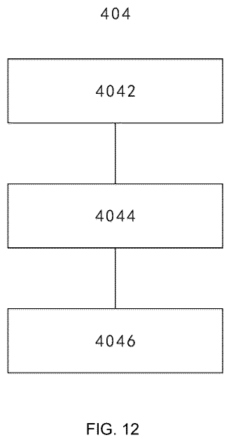

FIG. 12 shows a structural block diagram of the driving feedback unit 404. The driving feedback unit 404 comprises:
a completion score calculation unit 4042, which is configured to obtain a completion score R by calculation through the following formula and display same: R=(A*X)−(B*Y), where A is a total driving practice difficulty score of the road, X is correct driving mileage during the driving trip, B is an erroneous/dangerous driving coefficient (which may be preset by the user or the cloud server, for example, a danger coefficient of controlling the vehicle by frequently fine-tuning steering is 1, a danger coefficient of long-time driving on a solid line is 1, a danger coefficient of not starting the vehicle in time for a green light is 1, a danger coefficient of not slowing down in time for a red light is 2, a danger coefficient of being too close to a front vehicle due to delayed braking is 2, a danger coefficient of not turning on a turn signal during turning is 2, a danger coefficient of quick brake due to failure to observe traffic flow in time at an intersection is 3, a danger coefficient of encountering scratches is 5, or the like), and Y is erroneous driving mileage during the driving trip;
a dangerous behavior analysis unit 4044, which is configured to record data of a dangerous behavior during the driving trip (e.g. a video of the dangerous behavior captured by a vehicle camera or vehicle data of the dangerous behavior collected by other types of sensors, or the like), analyze the type and severity of the dangerous behavior (an analysis standard may be preset by the user or the cloud server), and provide an analysis result (e.g. which may be displayed by a display interface of the vehicle-mounted navigation system); and
a driving feedback providing unit 4046, which is configured to generate, on the basis of the completion score and the analysis result, a subsequent driving practice route suggestion (e.g. suggesting the user to increase or reduce a difficulty coefficient of a certain route, to increase the proportion of road sections in which the dangerous behavior occurs during a subsequent driving practice route, or the like), and provide driving feedback comprising the subsequent driving practice route suggestion to the user.

The recorded data of the dangerous behavior may be stored in the cloud server, and is pushed to other users requiring driving training for reference.

See FIG. 16 for a specific example of the driving feedback, as shown in FIG. 16, the driving feedback comprises total mileage of the trip (e.g. 88 km shown in the figure), a total duration of the trip (e.g. 3.3 h shown in the figure), and the subsequent driving practice route suggestion (e.g. “Speed control is not smooth enough for intersection scenarios, accelerated start and decelerated brake are not timely enough, and more urban intersection scenarios will be planned for you during a subsequent navigation routes! Keep going!”).

In one or more embodiments, the route planning system 300 and the navigation system 400 can be combined to obtain a route planning and navigation system for a driving training scenario.

In one or more embodiments, the route planning system 300 and the navigation system 400 can be integrated in a vehicle-mounted navigation system of a vehicle or integrated in the vehicle-mounted navigation system of the vehicle and a connected cloud server.

The present disclosure further provides a vehicle (not shown), comprising the route planning system 300 and the navigation system 400 as described above.

It is to be understood that the above specific embodiments are merely exemplary embodiments adopted to illustrate the principles of the present disclosure and do not constitute a limitation on the scope of protection of the present disclosure. Those skilled in the art should understand that various modifications, combinations, sub-combinations and substitutions can be made according to design requirements and other factors. Any modifications, equivalent substitutions, improvements, or the like made within the spirit and principles of the present disclosure shall be included in the scope of protection of the present disclosure.

1. A route planning method (100) for a driving training scenario, wherein the route planning method (100) comprises the following steps:
a road difficulty classification step (102): on the basis of static and dynamic attributes related to a road, classifying and marking the road by using different levels of driving practice difficulty; and
a route planning setting step (104): setting, on the basis of driving training preferences of a user, a route planned for the driving training scenario.

2. The route planning method according to claim 1, wherein the road difficulty classification step (102) comprises the following steps:
a predetermined difficulty coefficient setting step (1022): setting a plurality of corresponding predetermined difficulty coefficients for different static and dynamic attributes of the road;
a total difficulty score generation step (1024): on the basis of the plurality of predetermined difficulty coefficients, generating a total difficulty score for each section of the road;
a difficulty level determination step (1026): according to an interval in which the total difficulty score of each section of the road is located, determining a level of driving practice difficulty of each section of the road; and
a classification and marking step (1028): classifying and marking each section of the road with the level of driving practice difficulty of each section of the road.

3. The route planning method according to claim 2, wherein the road difficulty classification step (102) further comprises a user-customization step (1030) between the predetermined difficulty coefficient setting step (1022) and the total difficulty score generation step (1024): customizing one or more of the plurality of predetermined difficulty coefficients by the user to override the corresponding predetermined difficulty coefficients set in the predetermined difficulty coefficient setting step (1022).

4. The route planning method according to claim 1, wherein the route planning setting step (104) comprises the following steps:
a driving training preference priority presetting step (1042): presetting, by the user, priorities of one or more types of driving training preferences through a vehicle-mounted navigation system of a vehicle, and storing same in a processor of the vehicle-mounted navigation system or a cloud server connected to the vehicle-mounted navigation system;
a driving training requirement input step (1044): for the driving training scenario, inputting, by the user, specific numerical values of one or more of the one or more types of driving training preferences, wherein the specific numerical values indicate driving training requirements of the user for the driving training scenario;
a route calculation step (1046): on the basis of the priorities of the one or more types of driving training preferences preset by the user and the input specific numerical values of one or more of the one or more types of driving training preferences, calculating a corresponding route through the processor of the vehicle-mounted navigation system or the cloud server, and providing a calculation result, wherein the calculation result displays a proportion that the calculated corresponding route meets the driving training requirements of the user and/or whether each of the specific numerical values in the driving training requirements is met; and
a route determination step (1048): on the basis of the calculation result, determining, by the user, whether to accept the calculated corresponding route as a planned route for the driving training scenario, if the user accepts the corresponding route, starting, by the vehicle-mounted navigation system, a navigation service; and if the user does not accept the corresponding route, returning to the driving training requirement input step (1044), and re-inputting, by the user, modified specific numerical values of one or more of the one or more types of driving training preferences for the driving training scenario.

5. The route planning method according to claim 1, wherein the static and dynamic attributes related to the road include, but are not limited to, the number of intersections in the road, road and lane topological complexity, whether there is a road divider, dynamic traffic information, a road speed limit, or the like.

6. The route planning method according to claim 1, wherein the different levels of driving practice difficulty comprise three levels, i.e. easy, medium, and hard, and in the road difficulty classification step (102), the road is marked by using different colors corresponding to the different levels of driving practice difficulty in a navigation map displayed by the vehicle-mounted navigation system of the vehicle.

7. The route planning method according to claim 1, wherein in the road difficulty classification step (102), the road is classified and marked on the basis of one or more of the following in addition to the driving practice difficulty: driving styles on the roads, road layouts, road landscape layouts, and other special road situations.

8. The route planning method according to claim 1, wherein the driving training preferences include, but are not limited to, one or more of: a driving duration, a departure place of the route, a stopover, a preferred level and corresponding percentage of driving practice difficulty, a preferred driving scenario percentage, or the like.

9. A navigation method (200) for a driving training scenario, wherein the navigation method (200) comprises the following steps:
a navigation service step (202):
classifying and marking the road by using different levels of driving practice difficulty on the basis of static and dynamic attributes related to a road;
setting a route planned for the driving training scenario on the basis of driving training preferences of a user, and
providing guidance of the planned route to a user through audio broadcast and/or video display using a guidance method of a virtual driving instructor.

10. The navigation method according to claim 9, wherein the navigation method (200) further comprises a driving feedback step (204) after the navigation service step (202): after a driving trip of the route is completed, providing a variety of interactive game-like feedback to the user through a vehicle-mounted navigation system of a vehicle.

11. The navigation method according to claim 10, wherein the driving feedback step (204) comprises:
a completion score calculation step (2042): obtaining a completion score R by calculation through the following formula and displaying same: R=(A*X)−(B*Y), where A is a total driving practice difficulty score of the road, X is correct driving mileage during the driving trip, B is an erroneous/dangerous driving coefficient, and Y is erroneous driving mileage during the driving trip;
a dangerous behavior analysis step (2044): recording data of a dangerous behavior during the driving trip, analyzing the type and severity of the dangerous behavior, and providing an analysis result; and
a driving feedback providing step (2046): on the basis of the completion score and the analysis result, generating a subsequent driving practice route suggestion, and providing driving feedback comprising the subsequent driving practice route suggestion to the user through the vehicle-mounted navigation system of the vehicle.

12. The navigation method according to claim 11, wherein in the driving feedback providing step (2046), the recorded data of the dangerous behavior is stored in a cloud server connected to the vehicle-mounted navigation system of the vehicle, and is pushed to other users requiring driving training for reference.

13-20. (canceled)

21. A navigation system (400) for a driving training scenario, wherein the navigation system (400) comprises:
a navigation service unit (402),
which is configured to classify and mark, on the basis of static and dynamic attributes related to a road, the road by using different levels of driving practice difficulty;
which is configured to set, on the basis of driving training preferences of a user, a route planned for the driving training scenario; and
which is configured to provide guidance of the planned route to a user through audio broadcast and/or video display using a guidance method of a virtual driving instructor.

22. The navigation system according to claim 21, wherein the navigation system (400) further comprises a driving feedback unit (404), which is configured to provide, after a driving trip of the route is completed, a variety of interactive game-like feedback to the user through a vehicle-mounted navigation system of a vehicle.

23. The navigation system according to claim 22, wherein the driving feedback unit (404) comprises:
a completion score calculation unit (4042), which is configured to obtain a completion score R by calculation through the following formula and displaying same: R=(A*X)−(B*Y), where A is a total driving practice difficulty score of the road, X is correct driving mileage during the driving trip, B is an erroneous/dangerous driving coefficient, and Y is erroneous driving mileage during the driving trip;
a dangerous behavior analysis unit (4044), which is configured to record data of a dangerous behavior during the driving trip, analyze the type and severity of the dangerous behavior, and provide an analysis result; and
a driving feedback providing unit (4046), which is configured to generate, on the basis of the completion score and the analysis result, a subsequent driving practice route suggestion, and provide driving feedback comprising the subsequent driving practice route suggestion to the user.

24. The navigation system according to claim 23, wherein the driving feedback providing unit (4046) is further configured to store the recorded data of the dangerous behavior in a cloud server connected to the vehicle-mounted navigation system of the vehicle, and push same to other users requiring driving training for reference.

25. (canceled)
